(19) United States
(12) Patent Application Publication
(10) Pub. No.: US 2005/0126978 A1
(43) Pub. Date: Jun. 16, 2005

(54) Potting method for membrane module

(76) Inventors: Pierre Lucien Cote, Dundas (CA); Francois Yacoub, Oakville (CA); Steven Kristian Pedersen, Burlington (CA)

Correspondence Address: BERESKIN AND PARR, 40 KING STREET WEST, BOX 401, TORONTO, ON, M5H 3Y2, CA

(21) Appl. No.: 10/786,042

(22) Filed: Feb. 26, 2004

Related U.S. Application Data
(60) Provisional application No. 60/531,995, filed on Dec. 24, 2003.

(30) Foreign Application Priority Data
Dec. 11, 2003 (CA) 2,452,892

(51) Int. Cl. B01D 63/00

(52) U.S. Cl. 210/321.61; 210/321.88; 210/450

(57) ABSTRACT

A membrane module is made by inserting ends of membranes into a container and injecting resin directly into a space between adjacent membranes. The container may be a header shell having ducts for injecting the resin from outside of the header to the space between the adjacent membranes. The ducts may pass through a part of the header which forms a permeate cavity. The permeate cavity may be filled with a fugitive material while the resin is being injected.

This is an application claiming the benefit under 35 USC 119(e) of U.S. Provisional Application Ser. No. 60/531,995, filed Dec. 24, 2003. All of U.S. Ser. No. 60/531,995 is incorporated herein by this reference to it.

### FIELD OF THE INVENTION

This invention relates to membrane modules for water treatment and, more particularly, to potting membranes into a header.

### BACKGROUND OF THE INVENTION

Membranes can be used in water treatment units to extract permeate from a supply of water. Immersed membranes may be used for extracting clean water (permeate) from a tank of contaminated water containing solids or mixed liquor. The membranes may be potted in headers, and can be assembled in modules, each module having many membranes extending from a header. A source of suction can be provided to the headers to withdraw permeate through the membrane walls and into the lumens of the fibers. The permeate can then be drawn into a permeate collection cavity in or adjacent to the headers.

In one potting method, a layer of a fugitive material is provided in a potting container that can be a header shell. Ends of membranes to be potted are then inserted partway into the gel. Potting resin in a substantially liquid form can then be provided in a layer on top of the fugitive material. Once the resin has at least partially cured, the fugitive material can be evacuated, leaving a permeate cavity with which the insides of the membranes are in fluid communication.

### SUMMARY OF THE INVENTION

The inventors have observed that when potting membranes, for example hollow fiber membranes, using a known method such as, for example, but not limited to, the fugitive method, described above, a gap is typically provided between the outermost fibers in a bundle and the inner surface of the sidewall of the potting container. This gap provides room for a nozzle to be passed along the gap to lay down an amount of potting resin. The resin can migrate through the bundle of fibers (for example, under the force of gravity) and eventually make its way to the center of the bundle so that all of the fibers are satisfactorily potted.

This migration and leveling off of the resin generally takes a considerable amount of time. Also, uneven initial application of the resin (along the edges of the bundles) can disturb the underlying fugitive material and result in uneven resin thickness. Furthermore, the gap reduces the number of fibers that could otherwise be potted in the shell, since the potted header will be left with a “dead space” in the form of a border of cured resin where the gap formerly existed and in which generally no fibers are potted. Occasionally a stray fiber may become potted in the dead space border rather than with the bundle of fibers. Such stray fibers lack support of neighboring fibers, and for that reason, among others, are particularly prone to breakage. Breakage of the permeating fiber membranes can result in undesired contamination of the permeate.

It is an object of the invention to improve on the prior art. It is another object of the present invention to provide a membrane module of hollow fiber membranes and a method of making such a membrane module. It is another object of the present invention to provide a header for a membrane module having internal injection ducts that can be used for potting the hollow fiber membranes. It is another object of the present invention to provide a header for a membrane module that can, for a particular size of header, accommodate a greater amount of filtering membranes (i.e. improved ratio of active header area to “dead space”). It is another object of the invention to provide a module with structural elements spanning a permeate cavity. It is another object of the invention to provide a fugitive potting process that preserves a space for fluid flow between the end of the membranes and the walls of a header. These and other objects are provided by the features described in the claims. The following summary provides an introduction to the invention which may reside in a combination or sub-combination of features provided in this summary or in other parts of this document.

According to one aspect of the present invention, a header pan is provided with a plurality of tubes or ducts extending into the header. For example, the ducts may pass through what will be a permeate cavity in the header. The ducts have a first opening for introducing potting resin into them and one or more second openings for ejecting the resins. The second openings are located in an area to be filled with potting resin. The first openings may be located inside or outside of the header pan and are connected to a runner or other means for supplying liquid resin to the ducts. For example, the runner may be a channel glued or clamped to a side or bottom of the header pan with one or more openings in communication with the first openings of the ducts. To make a header, a fugitive material is placed in a part of the header pan that will be a permeate cavity. Ends of the membranes are inserted into the fugitive material. Liquid resin is injected into the first openings of the ducts, for example through the runner, flows through the ducts and out the second openings. The resin may be applied in steps separated by waiting periods which give time for the resin to flow across the header. The liquid resin is allowed to cure and the fugitive material is removed, for example through a permeate port. The ducts, filled with solid resin, may remain in the header where they provide a structural link between the resin and the header pan. The runner, if used, may also be left with the header or it may be removed and re-used. The ducts may be sized and shaped to provide minimal physical interference with the membranes such that membranes can be provided nearly uniformly across the header pan. The method may be adapted to other potting methods, for example methods not using fugitive materials, methods involving centrifugation and methods in which the fibers are potted first in a cavity that is not the header pan itself.

According to another aspect of the invention, a fugitive potting method uses two layers of fugitive materials. A first fugitive layer is provided adjacent the surface, for example the top or bottom surface, of a header shell. A second fugitive layer is provided adjacent the first layer. The first layer resists penetration of the fibers more than the second layer. The membranes are inserted into the second layer and may pass partially or completely through it. However, when the ends of the membranes reach the first layer, resistance to further penetration increases and the membranes are not inserted all the way through the first layer. A potting material is then provided adjacent the second layer and hardened. Both fugitive layers are then removed leaving a gap between the ends of the membranes and the inside surface or surfaces of the header shell. This gap provides a clear channel of about the thickness of the first layer for permeate flow through the header. The increased resistance to penetration of the first layer assists in providing this gap by providing a physical barrier to insertion of the fibers or by signaling to a person or machine inserting the fibers that the interface between the two fugitive layers has been reached.

### BRIEF DESCRIPTION OF THE DRAWINGS

For a better understanding of the present invention and to show more clearly how it may be carried into effect, reference will now be made by way of example, to the accompanying drawings that show embodiments of the present invention, and in which:

FIG. 1 is a perspective view of an embodiment of a module according to the present invention;

FIG. 2 is a top view of the module of FIG. 1;

FIG. 3 is a top view of a header shell of the module of FIG. 1;

FIG. 4 is a cross-sectional view of the header shell of FIG. 3 taken along the lines 4-4;

FIG. 5 is detailed cross-sectional view of a needle shown in FIG. 4;

FIGS. 6a-6c are cross sectional views showing the header of FIG. 1 at various stages in a potting process;

FIG. 7 is a side view of a runner attached to the header of FIG. 4;

FIG. 8 is a top view of an alternate module according to the present invention showing only the header shell;

FIG. 9 is cross-sectional view of the module of FIG. 7 taken along the lines 9-9; and

FIGS. 10a-10c are cross-sectional views showing the header of FIG. 1 at various stages in another potting process according to the present invention.

### DETAILED DESCRIPTION OF THE INVENTION

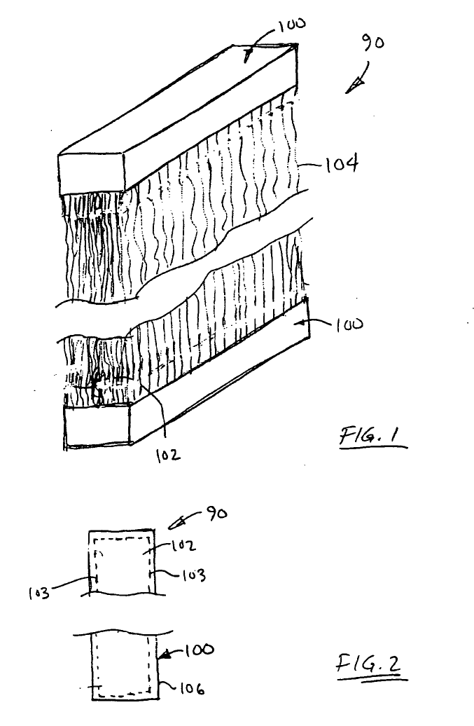

A filtration module 90 having a header potted according to the present invention is shown generally in FIG. 1. The module 90 has opposed headers 100 and a bundle 102 of permeating hollow fiber membranes 104 extending between the headers 100. The bundle 102 is configured in an elongate rectangular shape when viewed from above (FIG. 2), having a generally rectangular perimeter 103 (shown in phantom line) in a plane perpendicular to the axis of the hollow fiber membranes. Other configurations, such as, for example but without limitation, modules with a single header at one end of a bundle, modules with tow or more bundles of fibers, and headers/bundles with circular perimeters, or perimeters of other shapes, can also be provided within the scope of the present invention.

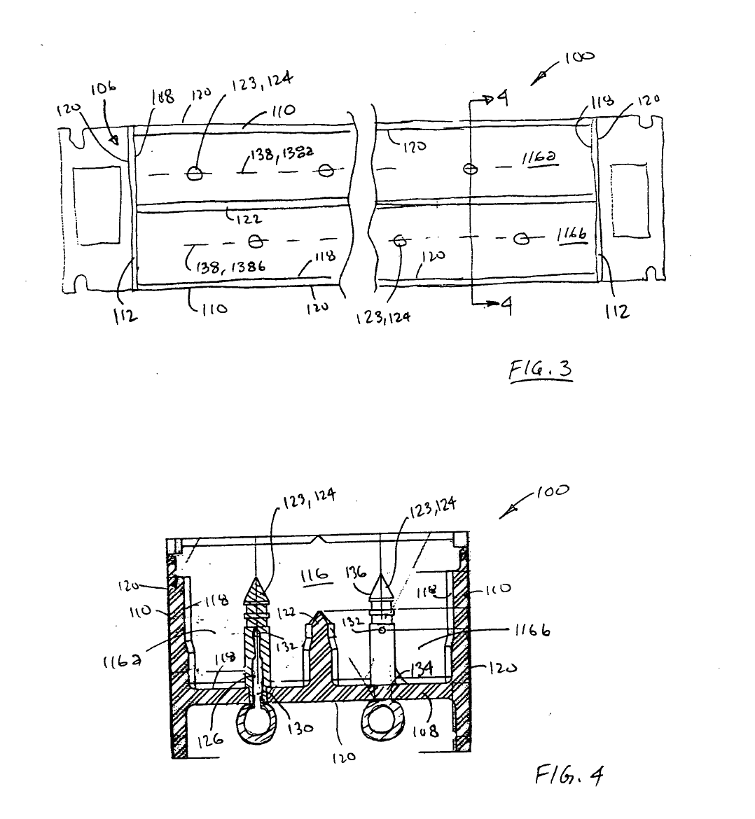

Referring now to FIGS. 3 and 4, each header 100 has a shell 106 that can be generally channel shaped and rectangular in cross-section. Each shell 106 has a base 108, and sidewalls 110 and end walls 112 that extend generally perpendicularly from the base 108. The sidewalls 110 and end walls 112 are spaced apart to define a recess 116 for receiving ends of the hollow fiber membranes 104. The surfaces of the base 108, sidewalls 110, and end walls 112 facing towards the recess 116 define the inner surface 118 of the shell 106. The surfaces of the base 108, sidewalls 110, and end walls 112 facing away from the recess 116 define the outer surface 120 of the shell 106.

In the embodiment illustrated, the shell 106 of the header 100 is further provided with an optional rib 122 that extends from the base 108, generally parallel to, and spaced between, the sidewalls 110. The rib 122 can divide the recess 116 into two smaller recesses 116a and 116b.

The header 100 is further provided with protrusions 123 that can be in the form of ducts or needles 124 extending from the shell 106 into the recess 116. As further described hereinafter, the needles 124 have internal injection ducts 126 for injecting a generally liquid material into the recess 116. In the embodiment illustrated, the needles 124 are generally cylindrical in shape, having lower ends 134 fixed to the base 108 of the shell 106, and upper ends 136 positioned between the sidewalls 110 of the shell 106. The needles 124 are arranged in two rows 138 of needles 124, each row 138 extending parallel to, and generally centrally between, the rib 122 and one of the sidewalls 110 (FIG. 3). In this way, a first row 138a of needles 124 is provided in the recess 116a, and a second row 138b is provided in the recess 116b.

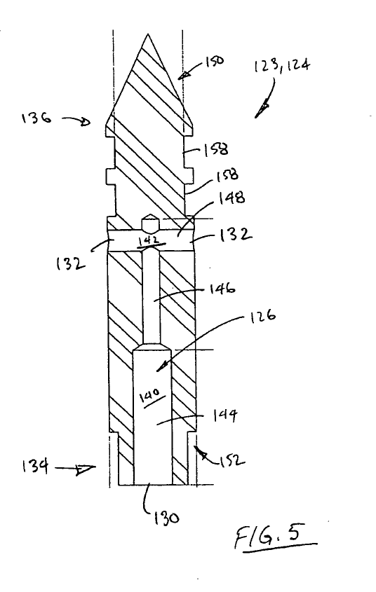

Referring now to FIGS. 4 and 5, the ducts 126 of the needles 124 have inlet ports 130 that open to the outer surface 120 of the shell 106, and discharge outlets 132 positioned in the interior of the recess 116. The ducts 126 comprise an axial passage 140 and a radial passage 142 (FIG. 5). The axial passage 140 has a lower portion 144 extending from the lower end of the needle 124 to a point about one third of the way along the height of the needle 124. The axial passage 140 has an upper portion 146 that extends from the lower portion 144 to a point about two thirds of the way along the height of the needle 124. The diameter of the lower portion 144 can be greater than the diameter of the upper portion 146.

The radial passage 142 comprises a cross-bore 148 that passes through the width of the needle 124 and intersects the upper portion 146 of the axial passage 140. The cross-bore 148 provides two discharge outlets 132 on opposite sides of the needle 124. In the header 100, the cross-bore 148 can be oriented generally parallel to the sidewalls 110 of the shell 106, so that the discharge outlets 132 are directed towards opposed end walls 112.

The needles 124 can be further provided with a deflector cap 150 at their upper ends 136. In the embodiment illustrated, the deflector cap 150 is an upwardly pointing conically shaped feature provided at the upper end 136 of each needle 124. The deflector cap 150 can facilitate potting of the fibers 104 in the header 100, as described in greater detail hereafter.

Each needle 124 can be a distinct element, separately attached to the shell 106 of the header 100. To facilitate attachment of the needles 124 to the shell 106, each needle 124 can be provided with a mounting surface 152 adjacent the lower end of the needle 124. The mounting surface 152 can include a cylindrical undercut portion that has a smaller outer diameter than an upper portion of the needle 124. The base 108 of the shell 106 can be provided with bores 154 each sized to receive the mounting surface 152 in a snug fit. An adhesive can be applied to the mounting surface 152 for securing the needle 124 to the shell 106.

Alternatively, at least a portion of the needles 124 may be provided integrally with the shell 106, by a process such as, for example, but not limited to, injection molding. In one embodiment, a lower portion of the needles including the axial passage could be integrally molded with the shell, and an upper portion having the deflector cap and radial passage could be separately attached to the lower portion.

Each needle 124 can further be provided with at least one annular groove 158 positioned to become embedded in the cured resin after potting. In the embodiment illustrated, each needle 124 has two spaced-apart annular grooves 158 positioned between the discharge outlets 132 and the deflector cap 150. The annular grooves 158 improve the physical bonds between the needle 124 and the cured resin which enhances the ability of the needle 124 to strengthen the header structure.

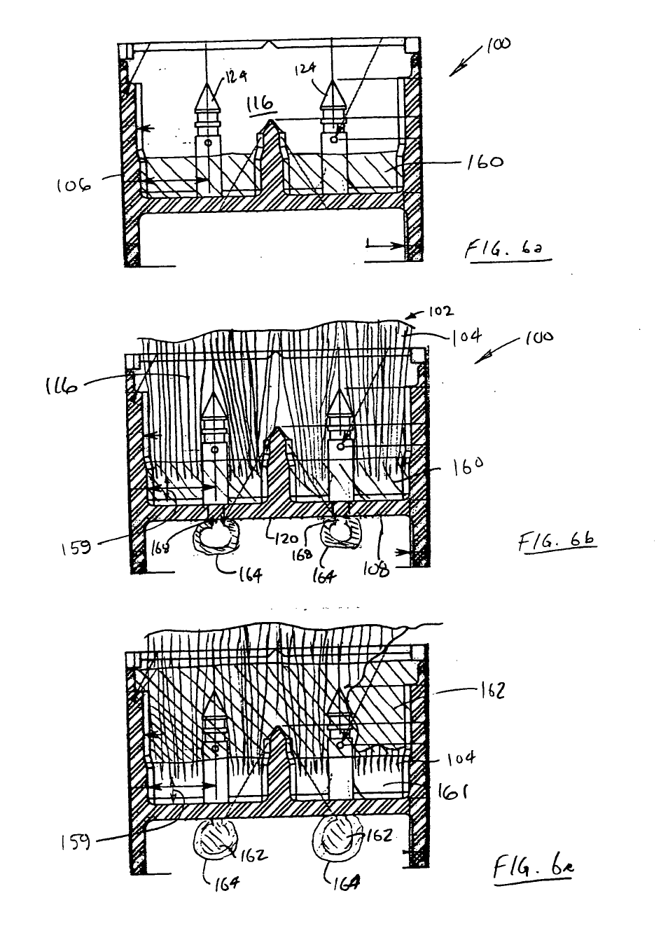

For potting the header 100, a fugitive material, such as a gel 160, can first be provided in a layer along the base of the shell (FIG. 6a). The ends of bundled hollow fiber membranes 104 can then be inserted into the recess 116 from above, and lowered into the gel 160 (FIG. 6b). The membranes 104 can be lowered partway down into the gel 160 to leave a space 159 between the ends of the membranes 104 and the inner surface of the base 108 of the shell 106. As the membranes 104 are lowered into the recess 116, the deflector cap can deflect the ends of the membranes 104 around the needles 124. As well, the sidewalls 110 and end walls 112 can guide the membranes 104 into the recess 116, thereby corralling the ends of the membranes 104 into the closely packed bundle 102 of spaced-apart membranes.

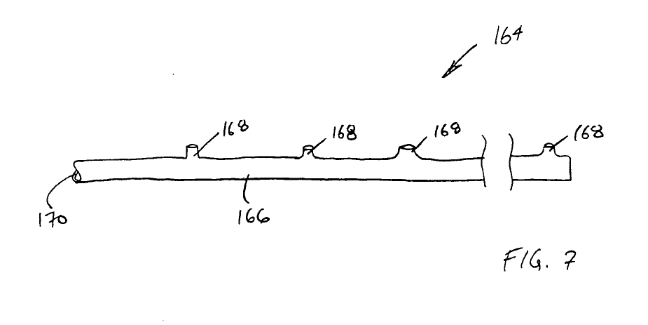

Potting resin 162 (see cutaway portion of FIG. 6c) can then be injected into the recess 116 through the needles 124, surrounding a portion of the length of the fibers 104 above the gel 160. To inject the resin 162, a potting runner 164 can be provided. Referring to FIGS. 6b and 7, the runner 164 can be in the form of a conduit 166 that extends along the outer surface 120 of the base 108 of the shell 106, with spaced-apart nozzles 168 extending from the conduit to engage the inlet ports of the ducts 126. The conduit 166 can be, for example, a tubular member constructed of plastic and may be of various cross sections such as round, square of C-channel. The runner 164 can be secured to the outer surface 120 of the shell 106 by, for example, a suitable adhesive. Alternatively, or additionally, the nozzles 168 can be sealingly secured to the inlet ports 130 of the ducts 126 and so fix the runner 164 to the shell 106.

The runner 164 can have an inlet 170 connected to a supply of resin and outlet nozzles 168 to dispense resin into the injection ducts 126. The runner 164 can have as many nozzles 168 as there are inlet ports 130 of the ducts 126, with each nozzle 168 being in fluid communication with one of the ports 130.

To pot the membranes 104, the potting resin 162 can be pumped through the runner 164, so that the resin 162 flows through the nozzles 168, into the ducts 126, and then into the recess 116 of the shell 106. The resin 162 can thus be supplied directly to an interior portion of the recess 116, and simultaneously at more than one location in the interior of the recess 116. In one method of potting the membranes 104 in the header 100, the resin 162 is pumped through the nozzles 168 in alternating cycles of higher pressure and lower pressure. The lower pressure cycle can allow some migration or leveling of the resin, between the higher pressure cycles. The lower pressure cycle can be an “off” condition in which no or virtually no resin pressure is provided at all.

Referring again to FIG. 6c, after injecting a desired amount of resin, the resin can cure, and once at least partially cured, the fugitive gel 160 can be removed, leaving a permeate collection cavity 161 with which the lumens of the membranes 104 are in fluid communication. At least some resin 162 will generally remain in the injection ducts 126 to seal the ducts 126 off from the permeate cavity 161. The runner 164 will generally also retain resin 162 that can cure, to further plug and seal off the permeate cavity 161 from untreated liquid outside the shell 106 when immersed. Alternately, the runner 164 can be stopped before the resin is cured and re-used or discarded, the resin in the ducts 126 sealing off the openings created as the runner is removed.

The inventors have observed that significant pressure differentials can be experienced between the permeate cavity 161 and the surrounding untreated water. This can place stress on the header shell 106, and cause arching of the header shell 106 and/or the resin layer 162. Without sufficient strength, the header shell 106 and/or the resin layer 162 can rupture, causing failure of the header. To strengthen the headers, one or more of the following techniques can be employed: using thicker wall sections to construct the header shell, providing reinforcing ribs in the shell, reducing the cross-sectional size of the header shell, or providing a thicker layer of resin.

Alternatively, or additionally, according to the present invention, the runner 164 can remain attached to the shell 106 to aid in reinforcing the header 100. The needles 124 also remain attached to the header, being generally embedded within the cured resin 162. The mechanical bond between the resin 162 and the needles 124 can reinforce the header by tying the resin layer 162 to the shell 106 along positions of the resin layer 162 disposed between the sidewalls 110 of the shell 106. This can permit an increase in the width of the header shell, while maintaining sufficient strength to withstand pressure differentials experience by the header during use or a reduction in sizes of other components for the same width of header. Resin filling the annular grooves 158 provided along the outer surface of the needles 124 can enhance the mechanical bond between the cured resin layer 162 and the needles 124.

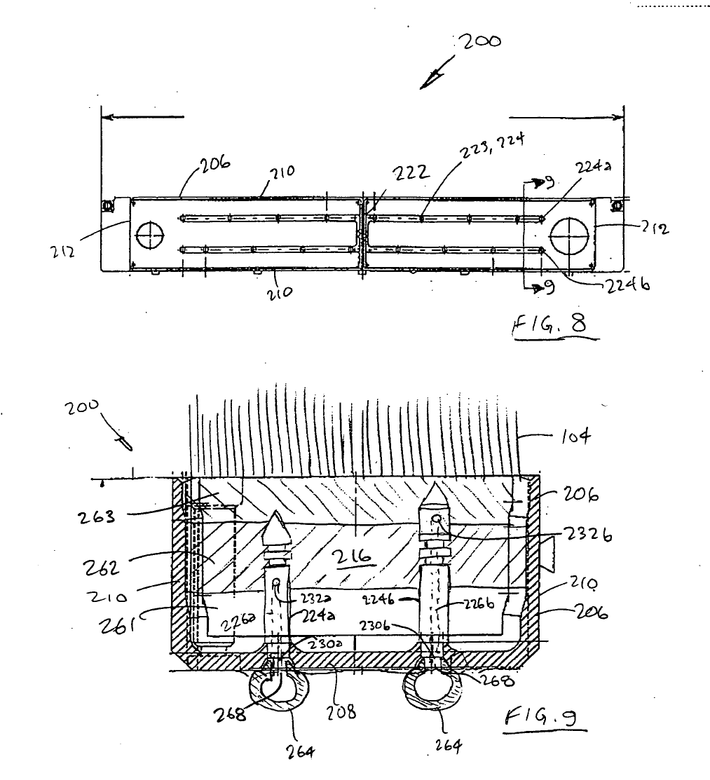

As best seen in FIGS. 8 and 9, an alternate embodiment of a header 200 according to the present invention has a shell 206 that is similar to the shell 106, but with an increased width. As well, the header 206 does not have a longitudinal rib (like the rib 122 of the header 100), but is instead provided with a transverse rib 222 at about the midpoint along the length of the shell 206.

The shell 206 can have a base 208, sidewalls 210, and end walls 212 to define a recess 216. The shell 206 has protrusions 223 in the form of needles 224 extending from the base 208 of the shell 206. The needles 224 extend into the interior of the recess 216, and injection ducts 226 are provided through the interior of the needles 224. The ducts are grouped into two sets of ducts. A first set of ducts 226a has discharge outlets 232a at a first, shorter distance measured generally normal from the base 208 of the shell 206, and a second set of ducts 226b has outlets 230b at a second, greater distance from the base 208 of the shell 206, relative to the first set of ducts 226a.

The distinct sets of ducts 226a, 226b can be used to inject two separate layers of material for potting the fibers 104. In the embodiment illustrated, the first set of ducts 226a, having lower outlets 232a, is used to supply a layer of potting resin 262 in the shell 206. The layer of resin 262 has a thickness that extends from above the permeate cavity 261 to a point below the outlets 232b of the second set of ducts 226b. The second set of ducts 226b, having higher outlets 232b, is used to inject a layer of cushioning material 263 on top of the potting resin 262. The potting layer 262 can be of a material such as, for example, but not limited to, an epoxy that cures to form a relatively hard, chemical resistant block of material. The cushioning layer 263 can be of a material such as, for example, but not limited to, silicone that cures to form a relatively softer material. The cushioning layer 263 can reduce the occurrence of fiber breakage, which, the inventors have observed, occurs most frequently at the point where the fibers 104 exit the potting.

The distinct ducts 262a and 262b can be provided in separate needles 224a, 224b, respectively. Alternatively, each needle 224 can have one duct 226a and one duct 226b, extending as separate passages between distinct inlet ports 230a, 230b and outlets 232a, 232b, respectively, which are connected to respective runners.

In other embodiments, the runner can be provided inside the header shell. Injection ducts can also be provided in other locations such as through the sidewalls of the header shell. Alternatively or additionally, ribs in the shell can be provided with injection ducts or an injection slot along part or all of the length of the rib. The runner can be constructed to be re-usable. Such a re-usable runner could have a conduit of steel, and nozzles that can engage the inlet ports of the injection ducts in a releasable sealed manner, for example through o-rings. The runner can be temporarily attached to the shell, for example with clamps, screws or other fasteners.

Referring again to FIGS. 6a-6c, the inventors have found that providing the space 159 between the ends of the potted fibers 104 and the base 108 of the shell 106 can facilitate evacuating permeate from the collection cavity 161 and/or the lumens of the fibers 104 at reduced head loss by providing a channel clear of membranes. Improved permeate evacuation can be particularly noticeable in headers where the potted bundle of fibers 104 has fibers 104 across substantially the entire width of the shell 106, such that little or no gap is provided between the outermost fibers 104 in the bundle and the inner surface of the sidewalls 110 of the shell 106.

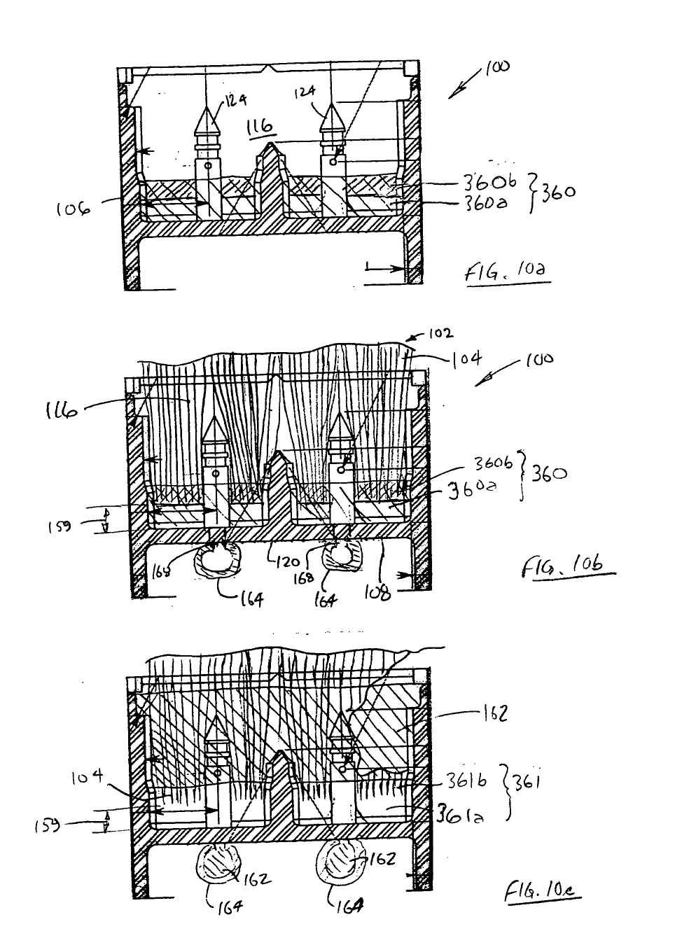

Referring now to FIGS. 10a-10c, to facilitate providing the space 159 between the ends of the fibers 104 and the shell 106, a fugitive multilayer 360 having two or more layers can be used in place of the single fugitive gel layer 160. More particularly, the fugitive multilayer 360 can have, with respect to insertion of the fibers 104 during potting, a generally less penetrable base layer 360a and a more penetrable upper layer 360b positioned on top of the base layer 360a (FIG. 10a).

The base layer 360a can be, for example, but not limited to, a a solid, a deformable solid, solid particles, a viscous liquid or gel, water that has at least partially frozen to form a layer of ice along its upper surface, or other material resistant to insertion of the fibers 104. For further example, a solidified gelatin may be used. The base layer 360a can have a depth of, for example, about 5 mm to 20 mm or more, the depth being chosen to create a free channel for permeate flow of a desired volume. The upper layer 160b can be, for example, a viscous gel in non-solidified form, through which the fibers 104 can be inserted but on top of which the potting resin 162 can be supported until cured or partially cured. Other materials, for example but without limitation waxes or powders, may also be used as may be appropriate to work with the base layer. The depth of the upper layer 160b can be, for example, about 5 mm to 20 mm or more.

During a potting process using the fugitive multilayer 360, the generally less penetrable base layer 360a can be provided by, in one particular embodiment, pouring liquid gelatin material into the shell 106. The gelatin can then set or solidify, to form the base layer 360a. The process by which the gelatin sets or solidifies can simply require waiting an appropriate length of time, or the process can include reducing the temperature of the gelatin. Once the base layer 360a has been formed, the more penetrable upper layer 360b of the fugitive multilayer 360 can be provided by applying gel on top of the base layer 360a (FIG. 10a).

The fibers 104 can then be lowered into the fugitive multilayer 360. The fibers 104 can penetrate partially or fully through the depth of the upper layer 360b, but will encounter increased resistance to further penetration when lowered to a depth where the ends of the fibers 104 contact the base layer 360a. Insertion of the fibers 104, if they have gone that far, can then be stopped. Even if some further lowering of the fibers 104 does occur, the fibers 104 will generally not penetrate deeply into the base layer 160a (FIG. 10b) and will not penetrate all of the way through it and so will still provide a space 159.

Potting resin 162 can then be injected into the shell 106 above the upper layer 360b of the multilayer fugitive 360 (FIG. 10c). A potting method using injection ducts as described previously herein can be used to provide the resin 162. Alternately, other methods of providing the potting resin may be used. Once the resin has cured or at least partially cured, the fugitive multilayer 360 can be removed from the shell 106. Removal of the multilayer fugitive 360 can include, for example, but not limited to, heating the multilayer fugitive 360, dissolving with water, pouring and/or flushing with chemicals such that the fugitive multilayer 360 is removed, and the membranes 104 and resin 162 are undamaged.

Once the fugitive multilayer 360 is removed, a two-part permeate cavity 361 remains between the base 108 of the shell 106 and the resin 162. The two-part cavity 361 has a lower part 361a formerly occupied by the base layer 360a of the multilayer fugitive 360, and an upper part 361b formerly occupied by the upper layer 360b of the fugitive multilayer 360. The lower part 361a of the permeate cavity 360 is substantially empty, devoid of any fibers 104, resin 162, or fugitive material. The upper part 361b of the permeate cavity 361 is generally occupied by the lower ends of the fibers 104 to the extend that they protrude from the resin 162.

Materials other than a solidified gelatin can be used for the generally impenetrable base layer 360a of the fugitive multilayer 360. Any layer of material that can provide a detectable resistance to the insertion of the fibers 104 can be used. Complete impenetrability is not required. For example, if the fibers 104 are inserted into the fugitive multilayer 360 by hand, a base layer 360a that is more viscous than the upper layer 360b can be sufficient. A person potting the fiber 104 can sense the difference in resistance to insertion of the fibers 104 as the ends of the fibers 104 pass through the upper layer 360b and engage the base layer 360a. Insertion of the fibers can then be halted, so that the space 159 remains between the shell 106 and the fibers 104. Similarly, a machine inserting the fibers 104 may be fitted with a sensor to detect that difference in resistance provided by the base layer 360a. The sensor is linked to the machine controls and instructs the machine to not insert the fibers 104 further when the base layer 360a has been reached. The base layer 360a and the upper layer 360b need not be of different material, but can be of the same material at different degrees of solidification or viscosity. For example, the base layer 360a can be of solidified gelatin, and the upper layer can be of gelatin that is only partially solidified or still generally liquid. Having the same material throughout the fugitive multilayer 360 can simplify removal of the fugitive multilayer, since a particular process and/or chemical effective for removal of one layer 360a or 360b can be used for the other layer as well.

While preferred embodiments of the invention have been described herein in detail, it is to be understood that this description is by way of example only, and is not intended to be limiting. The full scope of the invention is to be determined by reference to the appended claims.

1. A shell for a header for a water treatment module, comprising:
a) a shell having an outer surface and at least one recess for receiving ends of filtration membranes;
b) at least one protruding member extending from the shell to an interior of the recess c) at least one injection duct extending through the protruding member for injecting resin from outside the shell into the interior of the recess, the injection duct having an inlet open to the outer surface of the shell and a discharge outlet open to the interior to the recess.

2. The header according to claim 1 wherein the at least one protruding member comprises a needle, the needle having a lower end fixed to the shell and an upper end extending into the recess.

3. The header according to claim 2, wherein the injection duct extends from the lower end of the needle to the upper end of the needle.

4. The header according to claim 3 wherein the injection duct has an axial passage that extends from the lower end of needle to a point near the upper end, and a radial passage that extends from the upper end of the axial passage to the sidewall of the needle.

5. The header according to claim 4 wherein the radial passage extends through the width of the needle, providing two discharge outlets.

6. The header of claim 1 wherein the protruding member passes through an area of the shell adapted to contain a permeate cavity.

7. The header of claim 1 wherein the discharge outlet is located within an area of the shell adapted to contain a block of potting material holding membranes in the shell.

8. A method of potting membranes in a container comprising the steps of inserting ends of the membranes into the container and injecting resin directly into a space between ends of adjacent membranes.

9. The method of claim 8 further comprising placing a fugitive material in the container before inserting ends of the membranes into the container, the ends of the membranes being inserted into the fugitive material.

10. The method of claim 9 wherein the resin is injected through the fugitive material.

11. The method of claim 9 wherein the fugitive material is provided in at least two layers.

12. The method of claim 11 wherein one of the layers of fugitive material comprises a base layer that is resistant to the insertion of the ends of the membranes.

13. A method of potting membranes comprising the steps of (a) providing a first layer of a fugitive potting material into a potting container, (b) providing a second layer of a fugitive potting material in the potting container, (c) inserting the membranes at least partially into the second layer but not completely through the first layer, (d) providing and solidifying a potting material around the membranes outside of either the first or second layer and (e) removing the fugitive potting materials form the potting container.

14. The method of claim 13 wherein the second layer is less resistant to penetration on the membranes than the first layer.

15. The method of claim 14 wherein the potting container is a header shell and, in step (d) the potting material adheres to the header shell.

16. The method of claim 14 further comprising inserting the membranes completely through the second layer, sensing the increased resistance to fiber penetration as or after the membranes contact the first layer, and stopping insertion of the membranes as or after the increased resistance is sensed.
